(19) United States
(12) Patent Application Publication
(10) Pub. No.: US 2004/0264085 A1
(43) Pub. Date: Dec. 30, 2004

(54) Energy storage system

(75) Inventor: Guy C. Thrap, Del Mar, CA (US)

Correspondence Address: FOLEY & LARDNER, P.O. BOX 80278, SAN DIEGO, CA, 92138-0278, US

(73) Assignee: Maxwell Technologies, Inc.

(21) Appl. No.: 10/608,813

(22) Filed: Jun. 27, 2003

(51) Int. Cl. H02H 3/20

(52) U.S. Cl. 361/90

(57) ABSTRACT

An energy storage system is described for use in, for example, electronics systems such as a bank of computers. The disclosed energy storage systems allows the use of an efficient energy source, such as ultracapacitors, while providing a desired voltage level for an extended period of time. One embodiment of the energy storage system provides power to a load. The system includes a power module including at least one ultracapacitor adapted to store and discharge energy. The power module provides an output voltage as the ultracapacitor discharges energy. The system also includes a voltage regulator for boosting the output voltage of the power module. The voltage regulator may include a voltage converter. The voltage converter may be adapted to boost the output voltage when the output voltage falls below a predetermined threshold. The voltage converter may include a plurality of interleaving inductor circuits, each of the circuits including a switch and an inductor. The switches are adapted to be alternatingly closed and opened, thereby alternatingly storing energy in the inductors and discharging energy to the load.

### FIELD OF THE INVENTION

The present invention relates generally to energy storage systems. More particularly, the invention relates to energy storage systems incorporating ultracapacitors.

### BACKGROUND

The following description is provided to assist the understanding of the reader. None of the information provided or references cited is admitted to be prior art to the present invention.

Many systems or devices requiring an electrical power supply also incorporate a backup power supply to avoid disruptions in the operation of the system or device. This can be a critical requirement in the computing arena where, for example, a single power supply may be used for a bank of computers such as servers. The backup power supply can provide power during short gaps that may occur in the event of a temporary failure or fluctuation in the primary power supply or during a transfer from one primary power supply to another primary power supply.

Ideally, the backup power supply should be capable of storing power for an extended period of time, be able to provide substantially constant backup power for a required length of time (at least thirty seconds), and have the ability to recharge quickly.

Batteries have often been used for this backup purpose in many applications. However, batteries have several disadvantages. First, batteries tend to naturally deplete over time and lose their ability to store power, resulting in a shelf life of as little as approximately six months. Second, rechargeable batteries generally recharge at a much slower rate than their discharge rate. The long re-charging period can be a great disadvantage in systems that may experience frequent power failures or transfers. Third, batteries generally have a limited life span which may be dictated by the number of discharge/recharge cycles. A typical battery may be limited to approximately 2,000 cycles.

Ultracapacitors are capable of storing energy and provide the advantage of rapid rechargeability. Ultracapacitors can generally recharge at the same rate as the discharge rate. However, the output voltage from an ultracapacitor generally declines rapidly, thereby reducing the available time for the backup power. As an example, FIG. 1 illustrates the decline in the output voltage of an exemplary bank of ultracapacitors. The desired output voltage is generally a range of voltages. In this example, the desired range is indicated by the maximum (100%) voltage level and a minimum rated voltage level. A bank of ultracapacitors at full initial charge declines to the minimum voltage level rapidly (approximately 30 seconds in the example). By so rapidly reaching the minimum rated voltage, much of the energy stored in the ultracapacitors is rendered unusable. For example, only 45% of the energy stored in the ultracapacitors may have been used when the output voltage declines to the minimum rated voltage.

It is desirable to have a power source that provides a long storage life, constant output voltage for an extended length of time and the ability to recharge quickly.

Further, it may be desirable to employ an ultracapacitor-based power source to replace a battery supply. In this regard, it is advantageous to provide a power source which behaves like a battery as it discharges and, therefore, discharges in a predictable manner.

### SUMMARY OF THE INVENTION

The invention described herein relates to an energy storage system for use in, for example, electronics systems such as a bank of computers. The invention relates to an energy storage system which allows the use of an efficient energy source, such as ultracapacitors, while providing a desired voltage level for an extended period of time. Further, the embodiment provides for a power source which discharges according to a desired profile, thereby providing a predictable discharge behavior.

In one aspect, the invention includes an energy storage system for providing power to a load. The system includes a power module including at least one ultracapacitor adapted to store and discharge energy. The power module provides an output voltage as the ultracapacitor discharges energy. The system also includes a regulator adapted to regulate the output voltage of the power module. The regulator includes a discharge control circuit adapted to provide a predetermined voltage profile across the load. The profile is a function of a present voltage of the power module.

A load may be any unit or system requiring electrical energy. For example, a bank of computers such as a set of servers may require constant energy. The disclosed energy storage system is preferably utilized for backup power in case of failure or transition of a primary power system.

A “power module” may be a bank of ultracapacitors, such as twenty-two 2700-farad ultracapacitors connected in series. The power module may be implemented as a rack-mountable package containing the bank of ultracapacitors.

“Ultracapacitors” are well-known to those skilled in the art. Ultracapacitors generally include two current collecting plates, each having a corresponding electrode and being separated by a separator. Energy is stored in the form of a charge at the separated electrodes. For more detail on ultracapacitors, reference may be made to U.S. Pat. Nos. 5,621,607, 5,777,428, 5,862,035, 5,907,472, 6,059,847, 6,094,788 and 6,233,135, each of which is hereby incorporated by reference in its entirety.

In one embodiment, the discharge control circuit includes a comparator for comparing a voltage across the load to a reference voltage. A power stage for controlling the regulator based on an output of the comparator is also provided.

In one embodiment, the regulator includes at least one inductor circuit. In a preferred embodiment, the regulator includes two or more interleaving inductor circuits. Each of the interleaving inductor circuits includes a switch and an inductor. The switches are adapted to be selectively closed and opened, thereby selectively storing energy in the inductors and discharging energy to the load. The switches can be controlled by the discharge control circuit.

In another aspect, the invention provides a regulator circuit for regulating an output from a source powering a load. The regulator circuit includes an inductor circuit having at least one inductor and switching means for selectively opening and closing the inductor circuit for selectively discharging energy to the load and storing energy in the inductors. A discharge regulating circuit is provided and is adapted to control an output voltage profile. The discharge regulating circuit monitors a present voltage from the power source and controls the switching means in response to the present voltage.

In another aspect, the invention provides a regulator circuit having two or more interleaved inductor circuits, switching means for selectively opening and closing each of the inductor circuits for selectively discharging energy to the load and storing energy in the inductors, and a discharge regulating circuit. The discharge regulating circuit is adapted to control an output voltage profile. The discharge regulating circuit monitors a present voltage from the power source and controls the switching means in response to the present voltage.

While aspects and embodiments of the present invention are described herein, it would be understood that such descriptions are exemplary of uses and aspects of the presently described error detection and correction systems and methods and should not be limiting in content.

### DESCRIPTION OF DRAWINGS

FIG. 1 is a chart illustrating the output voltage degradation of an uncontrolled ultracapacitor bank discharge;

FIG. 2 is a diagrammatic illustration of one embodiment of an energy storage system according to the present invention;

FIG. 3 illustrates, in detail, one embodiment of an ultracapacitor bank for use with the energy storage system illustrated in FIG. 2;

FIG. 4A is a schematic illustration of one embodiment of an energy storage system with a voltage regulator according to the present invention;

FIG. 4B is a schematic illustration of another embodiment of an energy storage system with a voltage regulator according to the present invention;

FIG. 5 is a chart illustrating one sample output voltage of an embodiment of an energy storage system according to the present invention;

FIG. 6 illustrates one embodiment of an inductor according to the present invention;

FIG. 7A is a schematic illustration of one embodiment of an energy storage system with a discharge-controlling voltage regulator according to the present invention;

FIG. 7B is a schematic illustration of another embodiment of an energy storage system with a discharge-controlling voltage regulator according to the present invention;

FIG. 8 is a chart illustrating one sample output voltage of an embodiment of an energy storage system with a discharge-controlling voltage regulator according to the present invention;

### DETAILED DESCRIPTION

The present invention is generally directed to a power source adapted to provide power to a load. In this regard, the present invention includes an energy storage system which can provide long storage life, constant power for an extended length of time, and the ability recharge quickly.

The disclosed implementation of an energy storage system provides the ability to maintain a desired output voltage for an extended period while providing an energy source that can recharge rapidly and can last for practically unlimited number of recharge/discharge cycles.

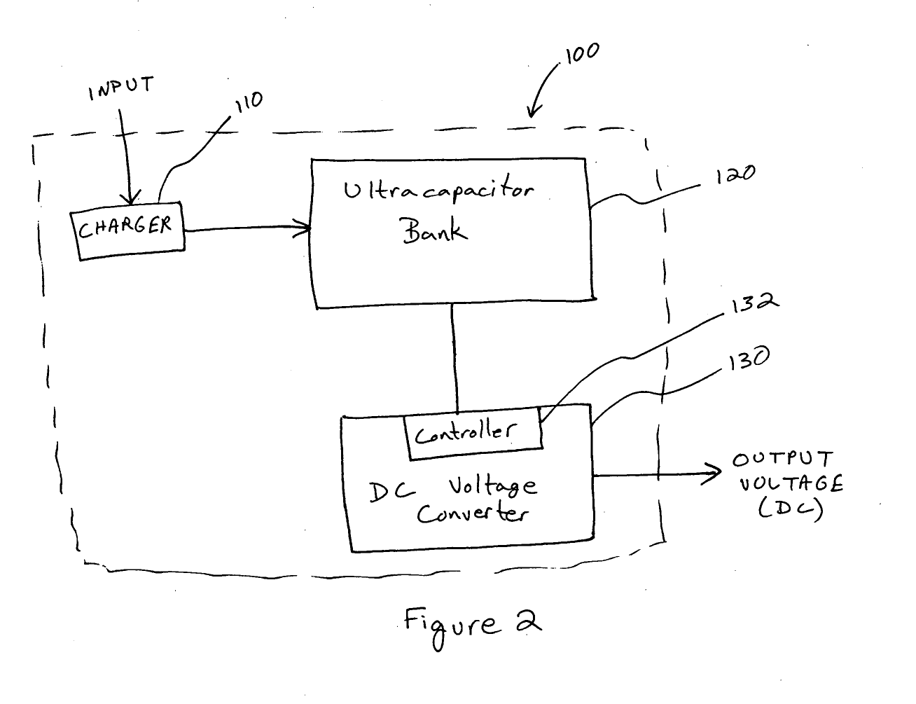

FIG. 2 illustrates one embodiment of an energy storage system according to the present invention. The energy storage system 100 can receive an input energy from a reservoir or a grid (not shown), for example. The input energy may be either direct current (DC) or alternating current (AC). A DC voltage is output by the energy storage system 100 to a load (not shown).

The input energy is directed to a charger 110 which may be provided within the energy storage system 100. The charger 110 is used to recharge a bank of ultracapacitors provided within a power module 120. The charger 110 may alternatively be provided separately from the energy storage system 100. The charger 110 is only utilized when the power module 120 is to be recharged with energy.

The power module 120 may contain any number of ultracapacitors to provide a desired energy level to the load. For example, a load requiring an average power of 4800 watts for 30 seconds, or 144,000 joules of energy, may be satisfied with two parallel banks of twenty-three 2700-farad ultracapacitors.

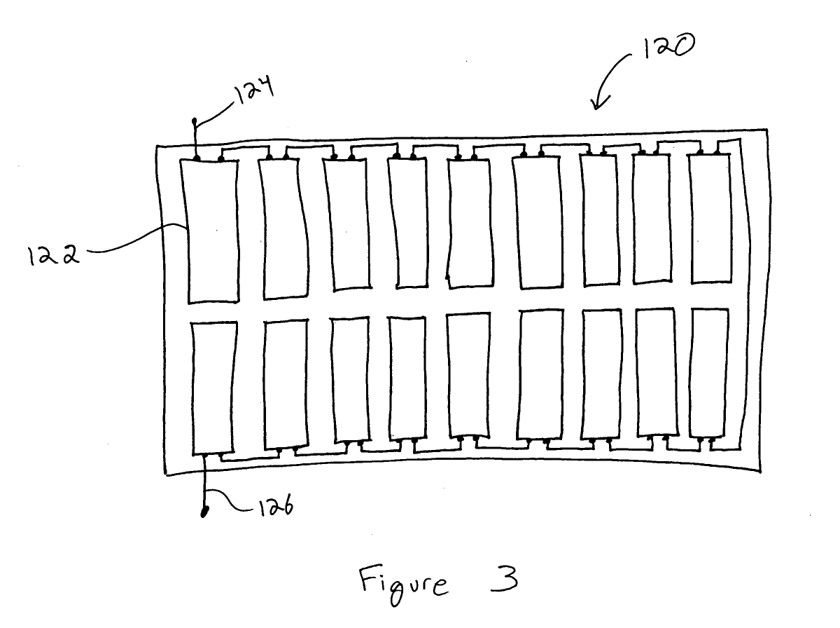

One embodiment of the power module 120 is illustrated in FIG. 3. The illustrated embodiment of the power module 120 includes a bank of ultracapacitors, such as ultracapacitor 122, connected in series. A pair of leads 124, 126 are provided to connect the power module 120 to the load. Either the same leads 124, 126 or another set of leads (not shown) may be used for charging the bank of ultracapacitors.

Referring again to FIG. 2, the energy storage system 100 further includes a voltage regulator module 130. The voltage regulator module 130 is adapted to convert the DC voltage from the power module 120 to an output voltage desired by the load. For example, as the bank of ultracapacitors in the power module 120 discharges, a drop in the voltage from the power module is experienced. As the voltage drops below a predetermined threshold, the voltage regulator module 130 may boost the voltage to assure the output voltage to the load is maintained within a desired range.

The voltage regulator module 130 may be provided with a controller 132. The controller 132 is adapted to detect the drop in the voltage from the power module 120 and, when the voltage drops below the predetermined threshold, to initiate a voltage conversion. The controller 132 may be implemented as hardware, firmware or software. In one embodiment, the controller is a microprocessor controlling one or more components of a circuit.

The predetermined threshold may be set at a level suited for a particular application. Preferably, the predetermined threshold is well above the minimum voltage requirement for the load. For example, the threshold may be set at the midpoint of the minimum and maximum voltage requirement of the load.

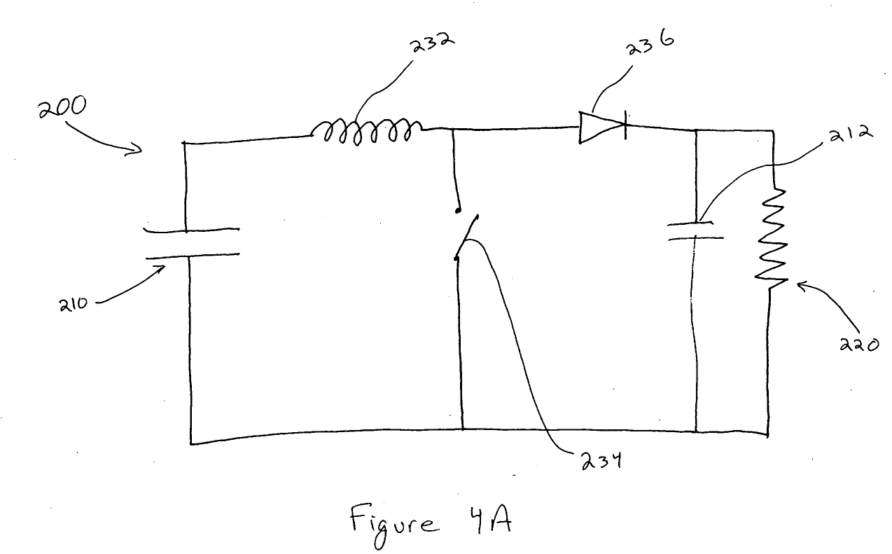

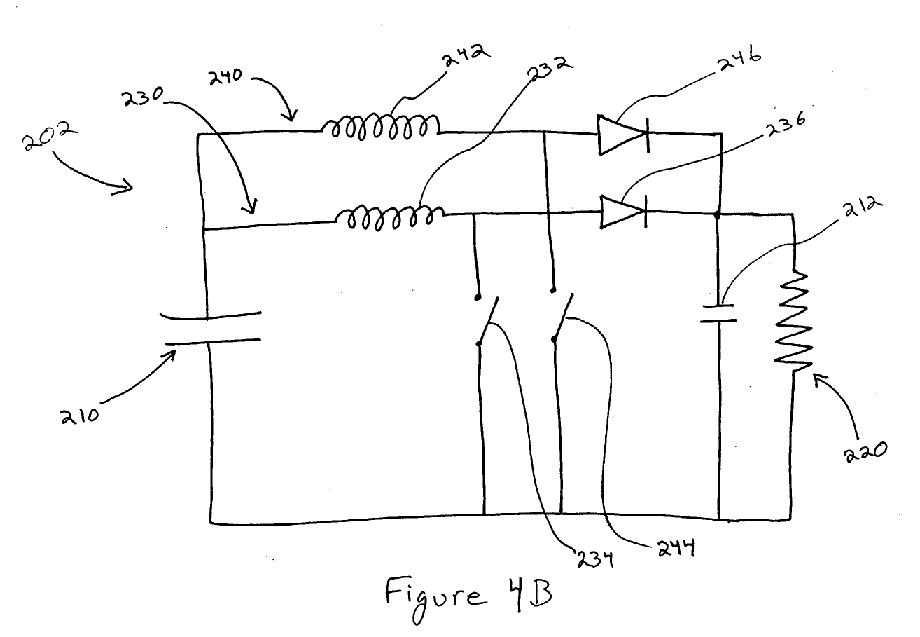

FIG. 4A schematically illustrates one embodiment of an arrangement using an energy storage system with a voltage regulator. In the illustrated energy storage system 200, a power module 210 provides electrical power to a load 220. The current from the power module 210 is directed through an inductor circuit 230. The inductor circuit 230 includes an inductor 232 and a switch 234. The induction level of the inductor 232 may be selected to achieve a desired result.

When the switch 234 is open (as illustrated), the current from the power module 210 flows through the inductor 232 and to the load 220, resulting in a voltage from the power module 210 being applied across the load 220. On the other hand, when the switch 234 is closed, the current passes through the inductor 232, but bypasses the load 220. Thus, the voltage from the power module 210 is applied across the inductor 232, causing energy to be stored in the inductor 232. When the switch 234 is subsequently opened, the voltage from the power module 210 as well as the stored energy in the inductor 232 is applied to the load.

The inductor circuit 230 is also provided with a diode 236. The diode 236 prevents backflow of current when the switch is closed. This prevents unintentional drawing of current from the load.

By selectively opening and closing the switch 234, the voltage across the load can be maintained at a higher level than that available directly from the power module 210, while the current passing through the load 220 is correspondingly reduced. The opening and closing of the switch 234 may be controlled by a controller, such as a microprocessor. Alternatively, the switch 234 may be adapted to be opened and closed at a regular frequency.

A capacitor 212 is provided across the load 220. The capacitor 212 prevents drastic changes in voltage across the load by storing and discharging energy. The capacitance level of the capacitor 212 is relatively small when compared to that of the power module 210.

The use of the inductor circuit 230 to boost the voltage across the load may cause a ripple in the voltage. In other words, a fluctuation in the voltage is experienced by the load. This ripple can be significantly reduced by providing two or more interleaved inductor circuits, as illustrated in FIG. 4B. Although the illustrated arrangement of FIG. 4B includes two inductor circuits 230, 240, a larger number of such circuits may be employed.

Each inductor circuit 230, 240 includes an inductor 232, 242, a switch 234, 244 and a diode 236, 246. In operation, each switch 234, 244 is alternatingly opened and closed. In one embodiment, when the first switch 234 is open, the second switch 244 is closed. Subsequently, the second switch 244 is opened, and the first switch 234 is closed. This is repeated at a frequency that is sufficiently high to produce a relatively smooth voltage profile applied to the load 220. In one embodiment, the alternating of the switches is performed at approximately 65 KHz.

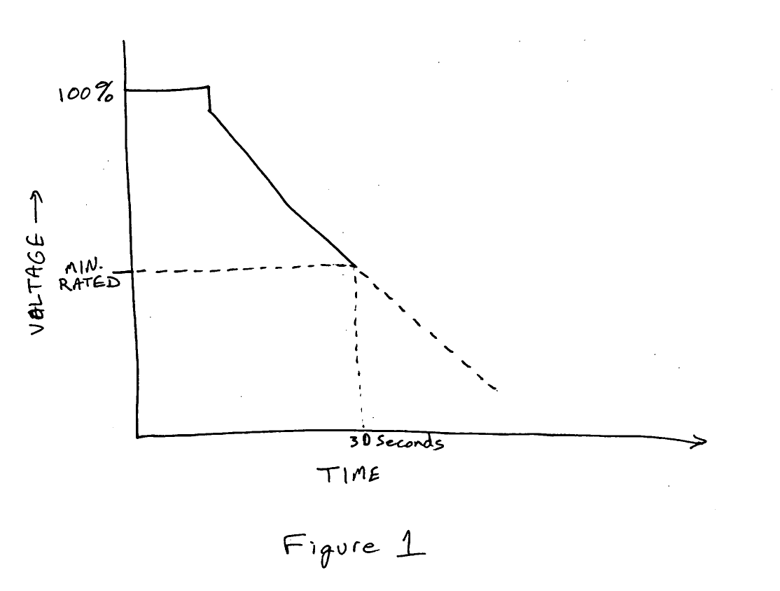

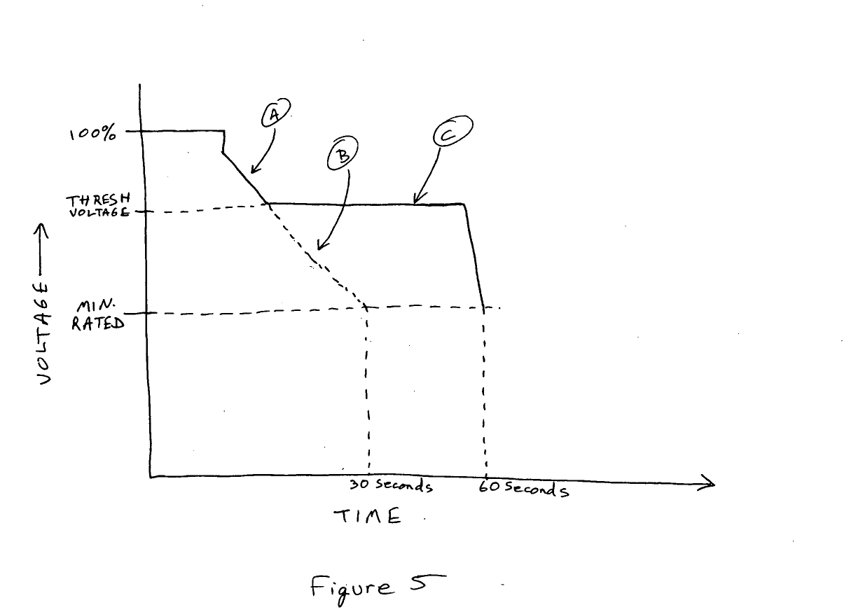

An exemplary voltage profile resulting from the above-described voltage regulation is illustrated in FIG. 5. When a fully charged, ultracapacitor power module is applied to a load, the voltage is initially at 100 percent of the rating of the power module. Preferably, this is substantially identical to the maximum voltage requirement of the load. Similar to the profile illustrated in FIG. 1, the output voltage from the power module begins to decline shortly after access by the load (segment A). Once the voltage from the power module reaches a threshold voltage level, the voltage regulation described above may be initiated. As a result of the voltage regulation, the rate of decline of the output voltage to the load is significantly reduced. Segment C indicates the voltage with regulation, and segment B indicates the output voltage with no regulation (same as that illustrated in FIG. 1). Thus, the output voltage can be maintained above a minimum voltage requirement of the load for a significantly longer period than without the voltage regulation. Further, a substantially greater amount of the energy available in the ultracapacitors of the power module is utilized. For example, whereas only 45 percent of the stored energy is utilized without voltage regulation (FIG. 1), voltage regulation allows use of 87 percent of the stored energy.

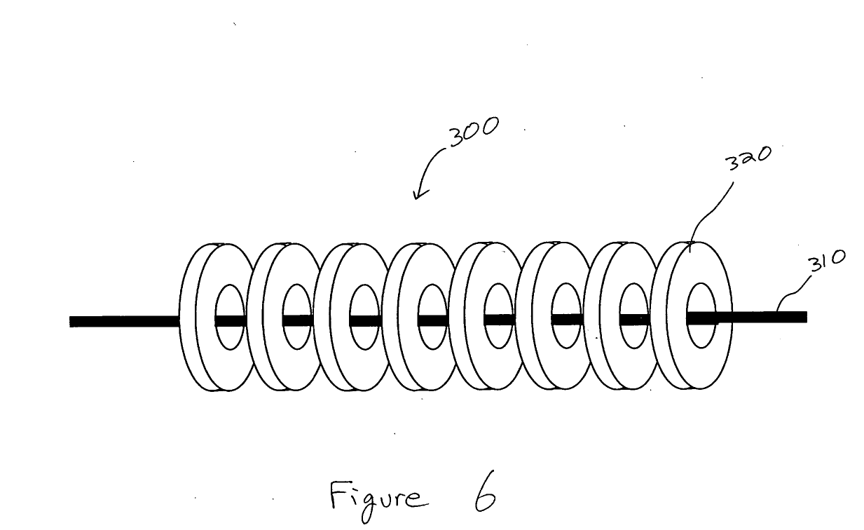

In one configuration, the bank of ultracapacitors is mounted within a rack-mountable module for use with a server rack which may contain a bank of computers, such as servers. The rack-mountable module is preferably 2 U (3.5 inches) in height and contains twenty-two ultracapacitors. Another embodiment of the rack-mountable module contains forty-six ultracapacitors and is 4 U (7 inches) in height. Similarly, the electronics including the voltage converter, controller and charger may be mounted in such a rack-mountable module. In this regard, an advantageous inductor configuration is utilized. FIG. 6 illustrates one embodiment of a low-profile inductor according to the present invention.

Traditional inductors include a single core made of a magnetizeable material, such as iron. The core is surrounded by a wire coil having a number of windings, each end of which constitutes a lead for connection in a circuit. Thus, the traditional inductor includes a single core with multiple windings.

On the other hand, the low-profile inductor 300 illustrated in FIG. 6 includes a single electrically conductive segment 310 passing through a plurality of rings 320. The rings 320 are made of a magnetizeable material, such as iron. The rings 320 are sized according to design requirements, as is the number of rings provided in the inductor 300. In one embodiment, the rings have an outer diameter of approximately 1 inch, an inner diameter of 0.25 inches and a width of approximately 0.125 inches. The rings are positioned in a spaced apart configuration along the length of the conductive segment 310. Preferably, the rings are equally spaced apart along the length of the segment 310.

The electrically conductive segment 310 is generally a linear wire segment through which current can flow when the segment 310 is connected to a circuit. The length and diameter of the segment 310 can be selected according to the requirements of the inductor 300. The conductive segment 310 can be made of any conductive material, such as copper or aluminum. When current flows through the segment 310, a magnetic field is created around the segment 310. The energy in the magnetic field can be stored in the rings 320.

This inductor configuration provides the inductor element 300 with a low profile, allowing implementation of the power module in the rack-mountable module. Further, the configuration illustrated in FIG. 6 offers improved thermal characteristics. By providing a greater surface area for the rings 320 than a traditional core, such as a cylindrical core, the illustrated embodiment allows greater heat dissipation, thereby providing more efficient operation of the inductor element.

In certain applications, the energy storage system described above may be used to replace a battery-based power source. Batteries offer the advantage of discharging according to a predictable slope. Thus, a load can recognize when the voltage is approaching a minimum acceptable level and can take appropriate actions, such as shutting down just prior to reaching the minimum acceptable level. In this regard, the present invention provides for a controlled-discharge voltage regulator to provide a desired discharge behavior to, for example, mimic the discharge behavior of a conventional battery. Thus, the predictability of a battery-based system may be achieved with all of the above-mentioned advantages of an ultracapacitor-based power system.

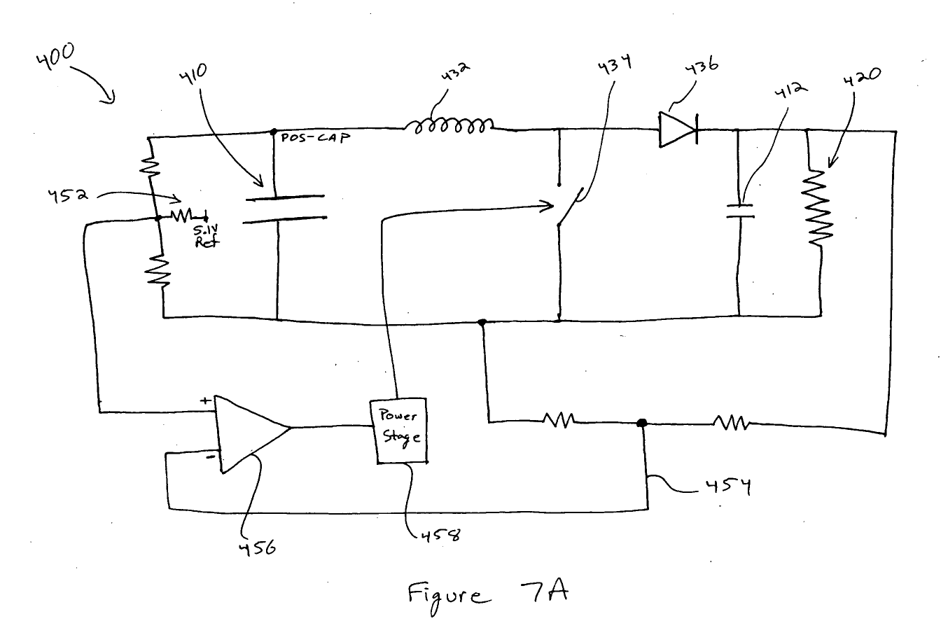

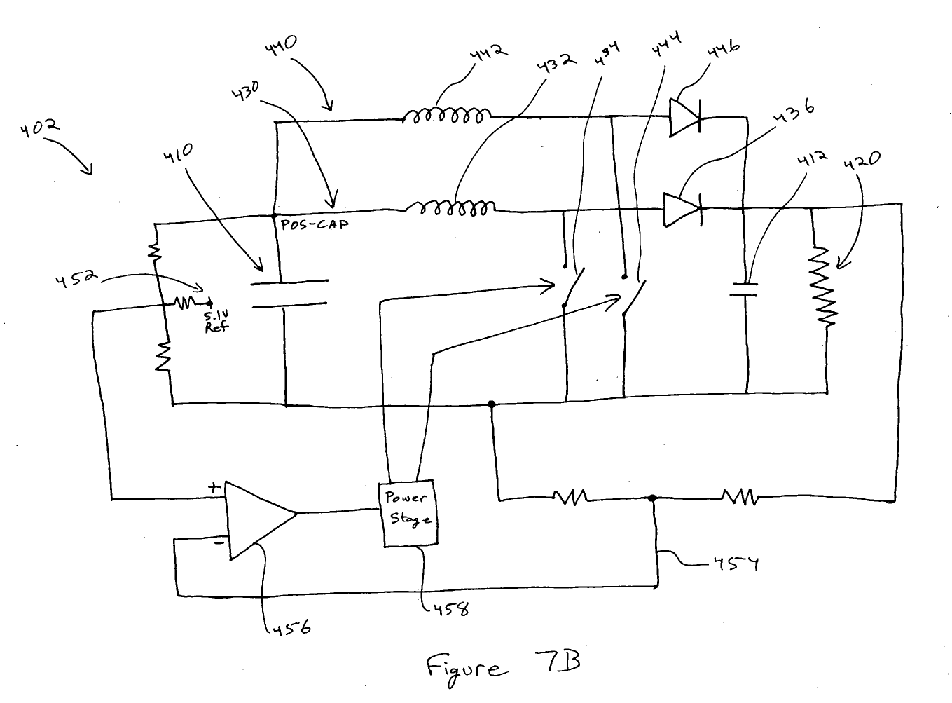

FIG. 7A illustrates one embodiment of an energy storage system with a controlled-discharge voltage regulator. As with the voltage regulators described above with reference to FIGS. 4A and 4B, the energy system 400 of FIG. 7A includes a power module 410 supplying power to a load 420. An inductor circuit 430 includes an inductor 432, a swith 434 and a diode 436. Further, a relatively low-level capacitor 412 is provided across the load 420.

A discharge control circuit 450 is provided to control the voltage profile across the load 420. The discharge control circuit 450 includes a reference voltage 452 of 5.1 volts provided across the power module 410. The reference voltage 452 is supplied to the positive input of a comparator 456. The negative input of the comparator 456 includes the voltage detected across the load 420 through line 454. Thus, the comparator 456 is able to determine the present voltage across the load 420. The phrase “present voltage” is used here to refer to the voltage detected, measured or determined by the comparator 456. It will be understood by those skilled in the art that such voltage may or may not be the instantaneous voltage.

The output of the comparator 456 is provided to a power stage 458. The power stage 458 may be a controller, such as a microprocessor. The power stage 458 includes information relating to a desired discharge profile. For example, the power stage 458 may be provided with information indicating a desired constant slope discharge once the voltage across the load 420 declines to a predetermined threshold.

Thus, through the output of the comparator 456, the power stage 458 can monitor the voltage across the load 420. When the voltage declines to the predetermined threshold, the power stage 458 begins control of the switch 434 of the inductor circuit 430 to achieve the desired voltage profile across the load 420. Thus, the discharge control circuit 450 serves as a feedback circuit to achieve the desired results. In this regard, the voltage across the load 420 is monitored through the comparator 456 and is controlled through operation of the inductor circuit 430. In this manner, any desired voltage profile can be achieved across the load 420.

As illustrated in FIG. 7B, an energy system 402 including a discharge control circuit 450 may be provided with a plurality of interleaved inductor circuits 430, 440, similar to those described above with reference to FIG. 4B. Each inductor circuit 430, 440 includes an inductor 432, 442, a switch 434, 444, and a diode 436, 446. The power stage 458 controls each switch 434, 444 of the inductor circuits 430, 440 to achieve the desired voltage profile. As noted above, the use of interleaved inductor circuits reduces fluctuations in the voltage across the load 420.

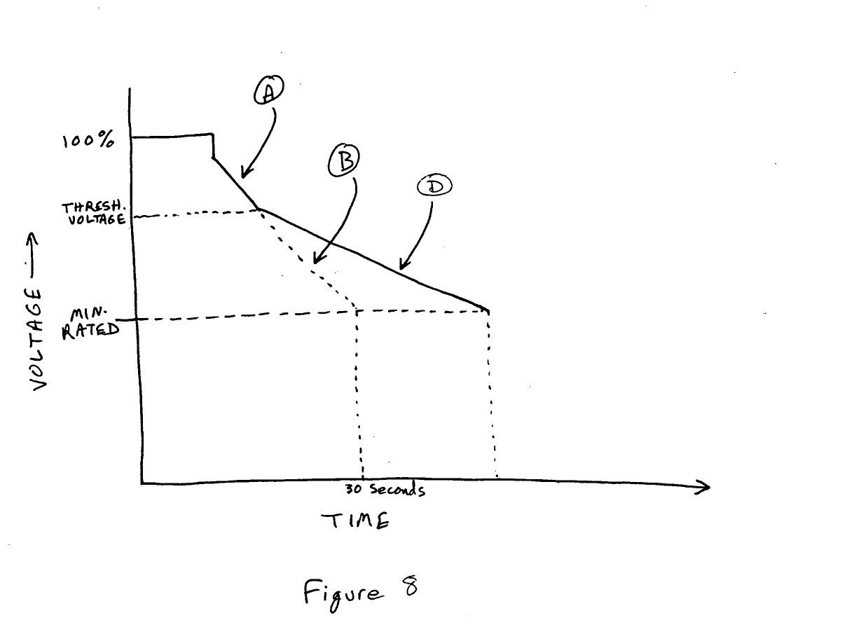

An exemplary voltage profile resulting from the above-described controlled-discharge voltage regulation is illustrated in FIG. 8. When a fully charged, ultracapacitor power module is applied to a load, the voltage is initially at 100 percent of the rating of the power module. Similar to the profiles illustrated in FIGS. 1 and 5, the output voltage from the power module begins to decline shortly after access by the load (segment A). Once the voltage from the power module reaches a threshold voltage level, the discharge-controlled voltage regulation described above is initiated. The example illustrated in FIG. 8 indicates a desired voltage profile which mimics the discharge of a battery-based power system. In this regard, the discharge is controlled to provide a constant-slope decline in the voltage across the load. Segment D indicates the voltage with discharge-controlled regulation, and segment B indicates the output voltage with no regulation (same as that illustrated in FIG. 1). Thus, the period of availability of an acceptable voltage level is considerably increased, while providing a predictable voltage profile. Thus, the disclosed energy storage system can effectively replace battery-based systems and provide all of the advantages of an ultracapacitor-based power system, while also providing the predictability o a battery-based system.

Thus, the disclosed embodiments provide an energy source with a long shelf life, short recharging time, an extended duration of the required voltage, and a predictable voltage profile.

While preferred embodiments and methods have been shown and described, it will be apparent to one of ordinary skill in the art that numerous alterations may be made without departing from the spirit or scope of the invention. Therefore, the invention is not limited except in accordance with the following claims.

We claim:

1. An energy storage system for providing power to a load, comprising:
a power module including at least one ultracapacitor adapted to store and discharge energy, said power module providing an output voltage as said ultracapacitor discharges energy; and
a regulator adapted to regulate the output voltage of the power module, said regulator including a discharge control circuit adapted to provide a predetermined voltage profile across said load, said profile being a function of a present voltage of said power module.

2. The energy storage system according to claim 1, wherein the discharge control circuit includes a comparator for comparing a voltage across said load to a reference voltage, and a power stage for controlling said regulator based on an output of said comparator.

3. The energy storage system according to claim 1, wherein the regulator is adapted to boost the output voltage when the output voltage falls below a predetermined threshold.

4. The energy storage system according to claim 1, wherein the regulator is adapted to boost the output voltage to a voltage within a predetermined range.

5. The energy storage system according to claim 1, wherein the regulator includes at least one inductor circuit.

6. The energy storage system according to claim 5, wherein said regulator includes two or more interleaving inductor circuits.

7. The energy storage system according to claim 6, wherein each of said interleaving inductor circuits includes a switch and an inductor, and wherein said switches are adapted to be selectively closed and opened, thereby selectively storing energy in said inductors and discharging energy to said load.

8. The energy storage system according to claim 7, wherein said switches are controlled by said discharge control circuit.

9. The energy storage system according to claim 6, wherein each of said interleaving inductor circuits is adapted to selectively pass current to said load and bypass said load.

10. A regulator circuit for regulating an output from an ultracapacitor power source powering a load, comprising:
an inductor circuit having at least one inductor;
switching means for selectively opening and closing said inductor circuit for selectively discharging energy to said load and storing energy in said inductors; and
a discharge regulating circuit adapted to control an output voltage profile, said discharge regulating circuit monitoring a present voltage from said power source and controlling said switching means in response to said present voltage.

11. A regulator circuit for regulating an output from an ultracapacitor power source powering a load, comprising:
two or more interleaved inductor circuits, each inductor circuit having at least one inductor;
switching means for selectively opening and closing each of said inductor circuits for selectively discharging energy to said load and storing energy in said inductors; and
a discharge regulating circuit adapted to control an output voltage profile, said discharge regulating circuit monitoring a present voltage from said power source and controlling said switching means in response to said present voltage.
